(19) United States
(12) Patent Application Publication
(10) Pub. No.: US 2014/0257998 A1
(43) Pub. Date: Sep. 11, 2014

(54) STORING CUSTOMER RELATIONSHIP MANAGEMENT INFORMATION IN A SOCIAL NETWORKING SYSTEM

(71) Applicant: Facebook, Inc., Menlo Park, CA (US)

(72) Inventors: Cole Jimison, Menlo Park, CA (US); Charles Peter Staples Dowd, Menlo Park, CA (US)

(21) Appl. No.: 13/794,243

(22) Filed: Mar. 11, 2013

(51) Int. Cl. G06Q 30/02; G06Q 50/00

(52) U.S. Cl. CPC G06Q 30/0277; H04L 67/306; G06Q 50/01
USPC 705/14.69; 709/204; 705/14.73

(57) ABSTRACT

An organization stores customer relationship management information in a social networking system. For example, the customer relationship management information is stored in a graph maintained by the social networking system. The graph includes nodes representing organizations and other objects maintained by the social networking system that are connected by edges. The edges store information describing relationships between the nodes, including information determining a user's authority to access an organization's resources or to act on behalf of an organization on the social networking system. The organization may reconstruct its customer relationship information from the graph and dynamically modify the edges used by the social networking system to represent the customer relationship management information.

### BACKGROUND

This invention relates generally to social networking systems, and in particular to storing customer relationship management information in a social networking system.

Social networking systems allow users to connect to and communicate with other users of the social networking system. Users create profiles on the social networking system that are tied to their identities and include information about the users, such as interests and demographic information. The users may be individuals or entities, such as corporations, organizations, or charities.

Social networking systems maintain a significant amount of user-specific information and information describing relationships between users on the social networking system. To allow users to regulate access to their information by other users, many social networking systems allow their users to grant or deny access to their user-specific information based on relationships with other users.

Conventionally, social networking systems allow organizations to maintain the same presence on social networking systems as individual users by allowing administrators authorized to act on behalf of organizations to create and maintain information associated with the organization. For example, administrators may create advertisements, create posts, respond to comments, and perform other activities on the social networking system on behalf of an organization. However, conventional social networking systems do not customize the rules of administrators based on the relationships between administrators and organizations or on the experience levels of various administrators. For example, a company may employ interns, mid-level staff, and managers in its advertising department, but all administrators associated with the company's social networking system account with advertising roles may have the same privileges for creating advertisements on behalf of the company. This provides no distinction between an intern's and manager's authority to create advertisements on the social networking system on behalf of the company. Additionally, conventional social networking systems to not maintain information about relationships between users and organizations allowing efficient retrieval and modification.

### SUMMARY

Social networking systems allow an organization to create and maintain a profile for connecting to and exchanging content with other social networking system users. For example, corporations may create profile pages and assign roles to administrators for managing the profile pages. However, conventional social networking systems often do not customized rules of different administrators based on different authority levels of the administrators in an organization. Thus, the social networking system may allow a temporary employee of an organization to delete all comments on an organization's profile page although the organization provides the temporary employee with internal authority to respond to, but not delete, comments dealing with a specific advertising campaign. Additionally a user may provide information about its relationship to an organization to the social networking system, but the organization does not verify the information to the social networking system. Further, while an organization may maintain information about users' relationships to the organization and authority associated with the users by the organization, conventional social networking systems are unable to easily retrieve or update information about the users from the organization's information.

To allow organizations to organize their relationships with other users and more easily manage their presence on social networking systems, a social networking system stores and organizes an entity's customer relationship management (CRM) information (i.e., relationships with existing and potential customers) into a graph maintained by the social networking system. The graph includes nodes each representing an organization (“organization nodes”) and connections (“edges”) between organization nodes and other nodes in the graph that represent objects maintained by the social networking system (e.g., users, advertising accounts, etc.). Hence, the graph describes relationships between the organizations and the other objects (e.g., employment relationships, privileges, etc.). The social networking system may retrieve the stored information to determine whether an user may act on behalf of an organization or access private information associated with the organization by the social networking system.

Storing an organization's CRM information in the graph allows the social networking system to update relationships between organization nodes and other nodes by modifying the edges of the graph. For example, when an organization establishes an employer-employee relationship with a social networking system user or modifies a social networking system user's authority to access data or to act on behalf of the organization, a connection between the user and the organization is maintained by the social networking system. The connection is stored as an edge in the graph between a node representing the user and an organization node. Data describing the edge may be created, changed, or deleted to reflect changes in the user's authority. This allows organizations to more easily manage security and/or privacy issues when users are associated with multiple organizations or when users switch associations with organizations. Thus, an advertising agency may delete relationship information stored in an edge between a client and an employee of the agency when the employee's relationship with the client is severed (e.g., the employee has completed her assignment for the client company).

Creating nodes for organizations and storing relationship information in connections between the nodes allows the social networking system to provide organizations with a variety of tools. For example, the stored graph allows an organization to reconstruct current organization-specific CRM data, allowing an organization to leverage data from the social networking system rather than store individual CRM information. For example, if the social networking system provides the organization with assistance in resolving issues reported by users about the organization's presence on the social networking system (“cases”), relationship information may be retrieved from edges connected to a corresponding organization node to identify users for participating in communication about the cases. For example, the social networking system may deny a user identified as a human resources employee of an organization access to communications about problems the organization has with creating an advertisement on the social networking system, but grant a user corresponding to an employee of an advertising agency working with the organization access to the communications.

In another embodiment, information stored in the graph about an organization's CRM allows the organization to easily make determinations concerning specific queries. For example, the amount of resources an organization devotes to advertising may be determined by accessing information about advertising accounts connected to the organization.

### BRIEF DESCRIPTION OF THE DRAWINGS

FIG. 1 is a block diagram of a system environment in which a social networking system operates, in accordance with an embodiment of the invention.

FIG. 2 is a block diagram of a social networking system, in accordance with an embodiment of the invention.

FIG. 3 is a flow chart of a method for maintaining a graph in a social networking system describing relationship information about an organization, in accordance with an embodiment of the invention.

FIG. 4 is an example graph maintained by a social networking system maintaining information about organizations and objects maintained by the social networking system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system stores and organizes information about organizations and their relationships to other objects maintained by the social networking system (such as users, advertising accounts, pages, etc.), allowing organizations to more easily manage their presence on the social networking system. An organization's customer relationship management (CRM) information is incorporated into a graph maintained by the social networking system by including an organization node representing the organization into the graph and establishing edges between the organization nodes and other nodes representing objects maintained by the social networking system. The edges store information describing relationships between the organizations and the other objects, including information specifying the authority of users connected to an organization to act on behalf of organizations. An implied relationship between users and an organization may also be stored in an edge between a user and an organization. For example, if a user buys an advertisement for an organization an edge may be created between the user and the organization with information about the advertisement purchase stored in the edge. Information stored in an edge may be updated to reflect changes in relationships between a user and an organization by creating, changing (e.g., reassigning), or severing the edge between a user and an organization (e.g., when an employer-employee relationship is created, changes, or is terminated). This enables an organization to more easily manage security and privacy issues associated with changes to a user's relationship with the organization. Additionally, information in the graph may be retrieved by the social networking system to reconstruct an organization's CRM, allowing more efficient communication among the social networking system, organizations, and other users.

The social networking system may use relationship information stored in an edge between a user and an organization node to determine whether to allow the user to access resources for or act on behalf of an organization corresponding to the organization node. For example, to determine whether a user should participate in communications about a case involving an organization, the social networking system may determine the user's relationship with the organization and authority to act on behalf of the organization based on information stored in an edge between a node representing the user and the organization's organization node.

The social networking system may also use information stored in an edge connected to an organization node to retrieve information for various queries. For example, the social networking system may retrieve information about advertising accounts stored in edges between the nodes representing the accounts and an organization node corresponding to the organization to determine an amount of money spent on the organization for advertising. As another example, the social networking system may use edges between nodes corresponding to advertisements and the organization node to identify advertisements used by the organization.

### System Architecture

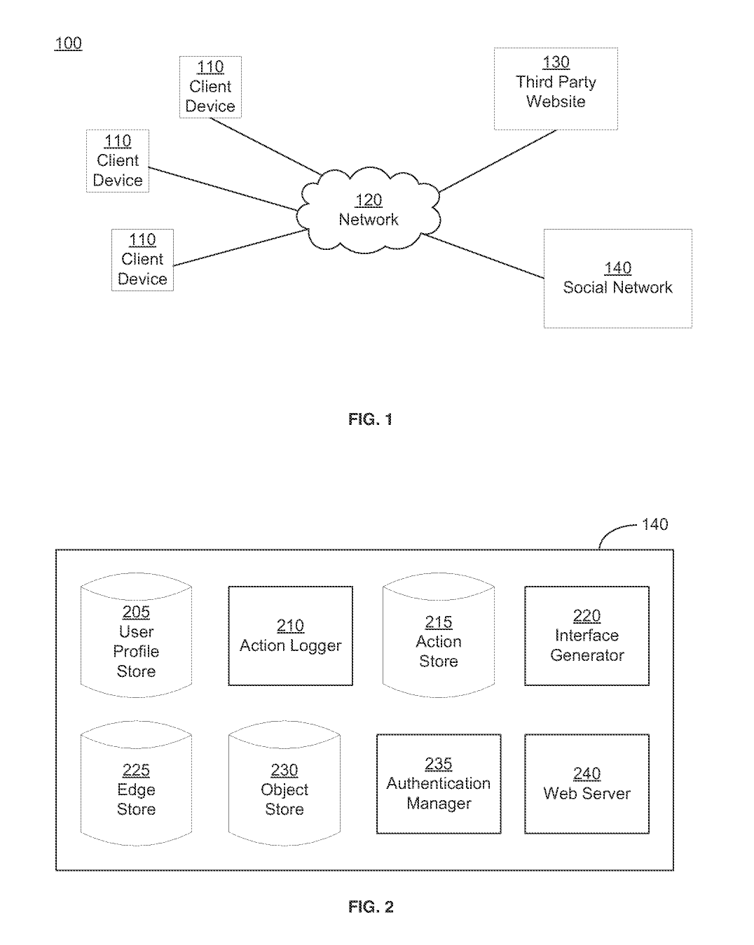

FIG. 1 is a high level block diagram of one embodiment of a system environment 100 for a social networking system 140. The system environment 100 comprises one or more client devices 110, a network 120, one or more third party websites 130, and a social networking system 140. In alternative configurations, different and/or additional components may be included in the system environment 100. The embodiments described herein may be adapted to online systems that are not social networking systems.

The client devices 110 comprise one or more computing devices capable of receiving user input as well as transmitting and/or receiving data via the network 120. In one embodiment, a client device 110 is a conventional computer system, such as a desktop or laptop computer. In another embodiment, a client device 110 may be a device having computer functionality, such as a personal digital assistant (PDA), mobile telephone, smart-phone or similar device. A client device 110 is configured to communicate via the network 120. In one embodiment, a client device 110 executes an application allowing a user of the client device 110 to interact with the social networking system 140. For example, a client device 110 executes a browser application to enable interaction between the client device 110 and the social networking system 140 via the network 120. In another embodiment, a client device 110 interacts with the social networking system 140 through an application programming interface (API) that runs on a native operating system of the client device 110, such as IOS® or ANDROID™.

The client devices 110 are configured to communicate via the network 120, which may comprise any combination of local area and/or wide area networks, using both wired and wireless communication systems. In one embodiment, the network 120 uses standard communications technologies and/or protocols. Thus, the network 120 may include communication channels using technologies such as Ethernet, 802.11, worldwide interoperability for microwave access (WiMAX), 3 G, 4 G, code division multiple access (CDMA), digital subscriber line (DSL), etc. Similarly, the networking protocols used on the network 120 may include multiprotocol label switching (MPLS), transmission control protocol/Internet protocol (TCP/IP), User Datagram Protocol (UDP), hypertext transport protocol (HTTP), simple mail transfer protocol (SMTP), and file transfer protocol (FTP). Data exchanged over the network 120 may be represented using technologies and/or formats including hypertext markup language (HTML) or extensible markup language (XML). In addition, all or some communication channels may be encrypted using conventional encryption technologies such as secure sockets layer (SSL), transport layer security (TLS), and Internet Protocol security (IPsec). The third party website 130 may be coupled to the network 120 for communicating with the social networking system 140, which is further described below in conjunction with FIG. 2.

FIG. 2 is a block diagram of an example architecture of the social networking system 140. In the example of FIG. 2, the social networking system 140 includes a user profile store 205, an action logger 210, an action store 215, an interface generator 220, an edge store 225, an object store 230, an authentication manager 235, and a web server 240. In other embodiments, the social networking system 140 may include additional, fewer, or different components for various applications. Conventional components such as network interfaces, security functions, load balancers, failover servers, management and network operations consoles, and the like are not shown so as to not obscure the details of the system architecture.

Each user of the social networking system 140 is associated with a user account that is typically associated with a single user profile, which is stored in the user profile store 205. A user profile includes declarative information about the user that was explicitly shared by the user, and may also include information inferred by the social networking system 140. A user profile may include multiple data fields, each describing one or more attributes of the corresponding user of the social networking system 140. Hence, user profile information stored in the user profile store 205 describes various social networking system users, including biographic, demographic, and other types of descriptive information, such as work experience, educational history, gender, hobbies or preferences, location and any other suitable information. User profile information may also include data describing one or more relationships between a user and other users. Additionally, the user profile store 205 may also store other information provided by the user, for example, images, or videos. A user profile in the user profile store 205 may also maintain references to actions performed by the corresponding user and stored in the action store 215.

While user profiles in the user profile store 205 are frequently associated with individuals, allowing people to interact with each other via the social networking system 140, user profiles may also be stored for entities such as businesses or organizations. This allows an entity to establish a presence on the social networking system 140 for connecting and exchanging content with other social networking system users. While an administrator or individual associated with the entity creates the user profile for the entity, the entity is identified as the account-holder associated with the user profile. The entity may post information about itself, information about its products, including catalogs of products, or provide other information to users of the social networking system 140 accessing a brand page associated with the entity's user profile. Other users of the social networking system 140 may connect to the brand page to receive information posted to the brand page or to receive information from the entity associated with the brand page. A user profile associated with an entity may provide users with background or informational data about the entity.

The action logger 210 receives communications describing user actions internal to and external to the social networking system 140. The action logger 210 populates the action store 215 with information describing user actions. When a user performs an action using the social networking system 140, the action logger 210 adds an entry to the action store 215 describing the action. Examples of actions include: posting a comment on a page, sending a message to another user, posting a photo, changing relationship status with another user, and attending an event. In addition, a number of actions described in connection with other objects are directed at particular users, so these actions are associated with those users as well. Some actions may be taken by users while not connected to the social networking system 140 and communicated to the social networking system 140 for storage when a connection is established.

The action store 215 maintains information describing actions by social networking system users internal to the social networking system 140, as well as actions performed via third party websites 130 that communicate information to the social networking system 140. Users may interact with various objects maintained by the social networking system 140, and these interactions are stored in the action store 215. Examples of actions or interactions stored by the action store 215 include: commenting on posts, sharing links, tagging objects, and checking-in to physical locations via a mobile device or other client device 110. Additional examples of interactions with objects on the social networking system 140 included in the action store 215 include commenting on a photo album, transmitting messages to another user, joining an event, joining a group, becoming a fan of a brand page, creating an event, authorizing an application, using an application, interacting with an advertisement, and engaging in a transaction.

The interface generator 220 generates one or more interfaces, such as web pages, including content from the social networking system 140. For example, interfaces generated by the interface generator 220 include images, video, profile information, or other data. The interface generator 220 also generates one or more interfaces allowing the social networking system 140 to request information from users and for users to provide information to the social networking system 140 via a client device 110 and the network 120. For example, the interface generator 220 generates a form for a user to provide biographic information, such as the user's age, for inclusion in the user's user profile. When other users request a user's profile page, the interface generator 220 retrieves data from the profile store 205 and generates a representation of the information in the user profile for presentation by a client device 110.

In one embodiment, the interface generator 220 also generates a node/edge user interface, which allows an organization to add, remove, or alter nodes and/or edges describing connections between the organization and users and/or objects maintained by the social networking system 140. For example, an organization may use the node/edge user interface to create a node representing an advertising account and an edge connecting the node representing the advertising account to a node representing an user that is an employee of the organization by manually entering such information or communicating information stored by the organization to the social networking system 140.

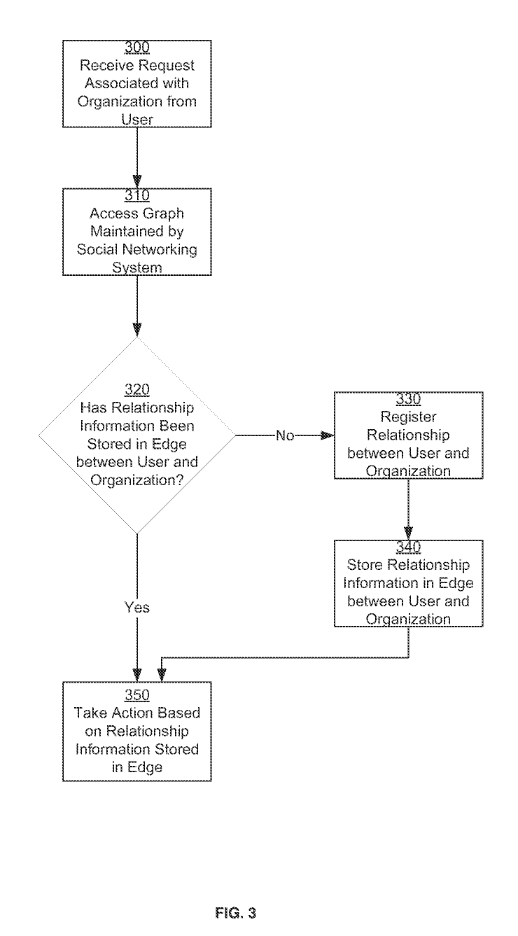

The node/edge user interface may allow multiple nodes and/or edges to be created at a time from information received from an organization (e.g., information identifying multiple users and their relationships to the organization). Additionally, the node/edge user interface may display options such as the type of node to be created, altered, or deleted (e.g., advertising account, advertising campaign, project, employee, etc.), the type of relationship to be created, altered, or deleted (e.g., manager, contractor, executive, etc.), and the type of authorizations to be created, altered, or deleted (e.g., to access financial information, to communicate with a particular client on behalf of an organization, etc.) for a user or an object. In one embodiment, the node/edge user interface obtains information for generating a node and/or an edge by requesting the information from a source using application programming interfaces (APIs) and/or a particular software development kit (SDK) or XML format. Creation or modification of nodes and edges is further described below in conjunction with FIG. 3.

The edge store 225 includes information describing connections between users and other objects in the social networking system 140 as edges. Some edges may be defined by users, allowing users to specify their relationships with other users. For example, users may generate edges with other users that parallel the users' real-life relationships, such as friends, co-workers, partners, and so forth. Generally, establishing a connection to a user in a social networking system 140 allows access to more information about the user to which the connection was established than would be available to unconnected users. For example, users connected to each other may receive informational updates about each other, including actions performed by each user on the social networking system 140, via stories presented on newsfeeds. Other edges are generated when users interact with objects in the social networking system 140, such as expressing interest in a page on the social networking system 140, sharing a link with other users of the social networking system 140, or commenting on posts made by other users of the social networking system 140. These edges may be visible to other social networking system users. Multiple interactions between a user and an object may be stored in a single edge in the edge store 225 or may each be stored as a separate edge. In some embodiments, connections between users may be stored in the user profile store 205, or the user profile store 205 may access the edge store 225 to determine connections between users.

The object store 230 stores information about content maintained by the social networking system 140. Different content “items,” each representing individual pieces of content provided by the social networking system 140 to users, are stored as objects in the object store 230. Examples of objects include applications (e.g., a game playable within the social networking system 140), events (e.g., a concert that users may attend), groups, pages, products or services (e.g., clothing, electronics, cleaning services, or beauty services) media items (e.g., pictures, videos, audio, text, or any other type of media content), locations associated with a user (e.g., “Santa Clara, Calif., USA”), concepts or other terms (e.g., “Victorian literature”), or other suitable data presented to users. The object store 230 may also store objects representing other data generated by social networking system users, such as messages, status updates, photos, videos, comments, notes, and postings. An object in the object store 230 may represent an entity existing within the social networking system 140 (e.g., an application available on the social networking system 140), an entity existing outside the domain of the social networking system 140 (e.g., a website), or a real-world entity (e.g., a sports team or a retail store).

The object store 230 may store data for generating content presented to social networking system users, such as code of an application or image data associated with image media. Alternatively, for objects representing entities outside of the social networking system 140, the object store 230 includes a pointer or a reference to a destination associated with an entity, such as the uniform resource locator (URL) of an external media item. Additionally, the object store 230 may store metadata associated with objects, such as a name describing the object (e.g. “Charles Williams” for a page for a person, “Birthday Reminder” for an application, or “Penguin Fanciers” for a group), an image representing the object (e.g., a user profile picture), or one or more tags assigned to the object by users (e.g. the textual strings “game,” “crime,” and “strategy” for a strategy game application). Different types of objects may have different types of metadata, such as a set of associated users for a group, a media type (e.g., “video”) for a media item object, and a unique user identifier or name tokens (e.g., separate first and last names “Charles” and “Williams”) for a an object representing a person.

The authentication manager 235 determines whether a relationship between a user and an organization allows the user to access the organization's information or resources or to act on behalf of the organization. When a request for the user to act on behalf of the organization is received, the authentication manager 235 identifies nodes in the graph maintained by the social networking system 140 corresponding to the user and to the organization involved and retrieves the information from the edge store 225 describing an edge between the identified nodes that describes the connection between the user and the organization. If the information stored in the edge is sufficient to support authorization of the requested action, the social networking system 140 allows the user to perform the requested action.

If the edge store 225 does not include data describing a connection between the user and the organization or describes a connection with insufficient authorization for the action, the social networking system 140 may request from the user authentication of a relationship between the user and the organization. For example, the authentication manager 235 sends a message identifying a user-provided relationship description to the organization associated with the content requested to be accessed and requesting authentication of the relationship by the organization. The message may be sent by any suitable communication channel, such as e-mail, instant messaging, SMS text messaging, or through the node/edge user interface. Similarly, the authentication manager 235 may send an authentication request including a relationship specified by an organization to users for authentication via similar methods. A relationship is authenticated when the social networking system 140 receives confirmation of the relationship descriptions from the party receiving the authentication request.

The authentication manager 235 may authenticate a relationship using preset authorization provided to a user by an organization that registers a connection between the user and the organization when received by the social networking system 140. For example, the authentication manager 235 may authenticate a relationship upon receiving preset passcodes from a user identifying the user's relationship to the organization. Different passcodes may correspond to different levels of privileges (e.g., manager, employee, contractor, etc.) specified by an organization, so that different users have different permissions based on their relationship to the organization.

The web server 240 communicates data between the social networking system 140 and one or more client devices 110, as well as one or more third party websites 130, via the network 120. The web server 240 serves web pages, as well as other content, such as JAVA®, FLASH®, XML and so forth. In one embodiment, the web server 240 receives and routes messages between the social networking system 140 and the client device 110, for example, instant messages, queued messages (e.g., email), text and short message service (SMS) messages, or messages sent using any other suitable messaging technique. A user may send a request to the web server 240 to upload information, for example, images or videos that are stored in the object store 230. Additionally, the web server 240 may provide application programming interface (API) functionality to send data directly to native client device operating systems, such as IOS®, ANDROID™, WEBOS® or RIM®.

### Storage, Retrieval, and Use of Relationship Information Between Users and Organizations

FIG. 3 is a flow chart of one embodiment of a method for maintaining relationship information associated with an organization by a social networking system 140. When the social networking system 140 receives 300 a request from a user to be authorized by an organization, the social networking system 140 accesses 130 a graph maintained by the social networking system 140 describing the relationship between the user and the organization. Based on the information stored in the graph, the social networking system 140 determines the user's relationship to the organization and uses the determined relationship to evaluate the received request.

Types of requests the social networking system 140 may receive 300 include requests to establish, alter, or delete connections between the organization and one or more users or other objects maintained by the social networking system 140. For example, a user may request to identify a list of employees and their relationship with an organization through the node/edge user interface, as described above, from a database for the social networking system 140 store information describing the relationship of the employees and the organization associated with connections corresponding to users corresponding to the employees and the organization. Examples of other requests include requests to create a connection describing a relationship between a user and an organization, deleting a connection between a user and an organization, modifying data describing a connection between a user and an organization, or other suitable actions. For example, a user may request to create multiple advertising accounts associated with an organization by providing information describing advertising accounts to the social networking system 140, which describes the advertising accounts and relationships between the advertising accounts and the organization.

The social networking system 140 may also receive 300 requests from users to perform an action on behalf of an organization. For example, a user may request to open a case or be involved in an existing case reported to the social networking system 140 about interactions between the organization and the social networking system 140. Additionally, the social networking system 140 may receive 300 a request from a user associated with an organization to communicate with another organization about a joint project involving the organizations. Further, the social networking system 140 may receive 300 requests from users for private information about an organization. For example, a user may request a summary of the amount of money an organization has spent on advertisements.

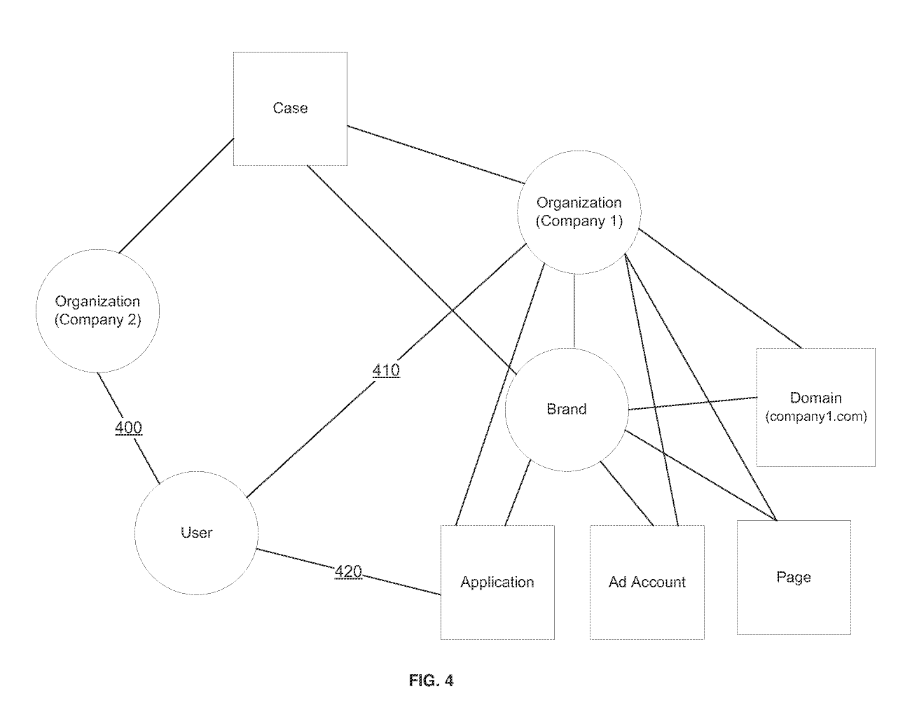

FIG. 4 shows an example of data accessed 310 by the social networking system to determine relationships among the objects. While FIG. 4 shows the data as a graph, in other embodiments, the social networking system 140 may store the data describing objects and relationships among objects in any suitable format. In FIG. 4, various objects are represented by nodes with edges representing connections between the nodes. Data associated with the edges describe the relationship that exists between a user or other object and an organization. In one embodiment, each object maintained by the social networking system 140 is represented as a node in the graph (e.g., organizations, agencies, employees, interns, applications, pages, advertising accounts, domains, etc.) with connections between objects represented as edges between the corresponding nodes. Information describing the relationship between an object and an organization is stored in the edge describing the connection between the object and the organization (e.g., employer-employee relationships, types of work being performed, security access information, etc.). For example, a user may be a copywriter for an advertising agency (represented as Company 2) who is working on an advertisement for an application created by Company 1. Therefore, an edge 400 between a node corresponding to Company 2 and a node corresponding to the user 400 may describe the user as a senior copywriter authorized to act on behalf of Company 2 regarding an advertisement for the application created by Company 1. Likewise, an edge 410 between a node corresponding to Company 1 and the node corresponding to the user includes information describing the user as an employee of Company 2 working on an advertisement for the application. Similarly, an edge 420 between the node corresponding to the user and a node corresponding to the application includes information describing the user as the project manager in charge of an advertisement for the application.

After identifying content identifying the user and the organization, such as a node corresponding to the user and a node corresponding to the organization, the authentication manager 235 determines 320 whether the edge store 225 includes a connection between the user and the organization. For example, the authentication manager 235 determines 320 whether an edge in the edge store 225 describes a connection between the user and the organization. The authentication manager 235 accesses relationship information associated with the connection describing a relationship between the user and the connection to determine if the user is authorized to perform an action identified by the request. If the social networking system 140 does not include information describing a connection between the user and the organization or if the information describing a connection between the user and the organization does not describe a relationship allowing the user to perform the requested action, the social networking system 140 may register 330 a connection between the user providing the request (the “requesting user”) and the organization. To register a connection, the social networking system 140 may send an authentication request to the organization and receive authentication information (e.g., preset passcodes, etc.) as described above. The authentication information may be stored 340 in an edge describing a connection between the user and the organization. In one embodiment, registration of a connection provides for a temporary connection between the user and the organization, such as a connection that expires on a specified date or after a specified length of time. For example, a provisional connection between an organization and a temporary employee that will expire on a specified date is stored.

If there is an edge connecting the user and the organization or other data describing a connection between the user and the organization, the information from the edge describing the relationship between the user and the organization is retrieved and the social networking system 140 takes 350 an action based on the relationship. Actions the social networking system 140 may take 350 include performing an action included in the request or denying performance of the action included in the request. In one embodiment, if the request is to access an organization's CRM information but conflicting CRM information is stored by the social networking system 140, the discrepancy is resolved using information about the requesting user and about the organization to select the information provided to the requesting user. Resolving discrepancies in information stored in a graph maintained by a social networking system 140 is further disclosed in U.S. patent application Ser. No. 13/455,050, filed on Apr. 24, 2012, which is incorporated herein by reference in its entirety. In another embodiment, the social networking system 140 notifies the user that the request was denied because the organization denied the authentication request or has not yet responded to the authentication request.

The social networking system 140 may also grant a user limited authority to perform an action associated with the request based on relationship information stored along with a connection between the user and the organization. An administrator of the organization may designate different levels of authority available to users connected to an organization depending on the users' relationships with the organization. The designated level of authority may depend on factors such as the user's experience with the organization, the user's position within the organization, agreements between the user and the organization, or any other suitable information. In one embodiment, if a user is granted limited authority, the user may be limited to accessing specific subsets of private information (e.g., relating to a particular account) depending on the type of relationship between the user and the organization.

### Updating CRM Information

An organization may be connected to various objects maintained by the social networking system 140, such as the organization's advertising accounts, cases, campaigns, users, etc., which are connected to users. A user's relationship with an organization or other objects connected to the organization is dynamic and may correspond to different levels of authority for acting act on behalf of the organization or for accessing private or privileged data on the social networking system 140 associated with the organization. For example, relationship information stored in an edge connecting a user and an organization may specify a user's authority to access information or resources for a particular project, but not to access information for other projects.

Additionally, the graph or other data maintained by the social networking system 140 may be updated to reflect dynamic CRM data for an organization. For example, when an employer-employee relationship is created, is modified, or is terminated, relationship information stored in the edge between the user and the organization is created, modified, or deleted. When relationship information stored in an edge between an organization and a user is updated, authorization information (e.g., privileges or security access) associated with the user is updated based on the updated relationship information.

In one embodiment, when a user no longer has a relationship with an organization or the user's relationship changes (e.g., an intern finishes his internship, an employee is fired/promoted, etc.), data describing the connection between the user and the object is removed or modified to limit the user's ability to perform actions on behalf of the organization. An existing connection between an organization and a different user may be reassigned to connect the organization and a different user. This allows organizations to easily manage security and privacy issues when a user's authority to act on behalf of an organization changes. For example, if a user is an employee of an organization and has been promoted to a management position, information stored in an edge connecting a node representing the user to a node representing the organization is updated to include the user's new position and any associated access to privileged information of the organization.

### User Communications on Behalf of Organizations

When two or more organizations communicate with each other on the social networking system 140, users involved in the communications may be required to have authorization to act on behalf of the organizations. Relationship information describing connections between the users and the organizations may be accessed to determine whether the relationships between the users and the organizations provide the user with authorization to act on behalf of their respective organizations. When a user associated with one organization communicates with a user from a different organization, the social networking system 140 may retrieve stored information describing the users' relationships with their respective organizations. This relationship information may be presented so that each user receives information about the other user's relationship to the organization for which it is communicating. For example, information about the users' relationships to the organizations may be presented before communications are sent (e.g., in a separate message) or it may be included in communications between the users.

In one embodiment, relationship information stored in connections between users or organizations is used to determine whether a user should receive communications associated with a case involving an organization. For example, the social networking system 140 opens a case when a user requests assistance from the social networking system 140 relating to an issue involving an organization's presence on, or interactions with, the social networking system 140. When a case is opened, the social networking system 140 may receive requests from users to participate in communications about the case. For example, the social networking system 140 receives a request from a user who is not an employee of an organization to be included in communications about a case involving the organization. Although the user is not an employee of the organization, the social networking system 140 may determine from relationship information stored in a connection between the user and the organization that the user is an employee of an agency working with the organization on a project related to the case. Based on the relationship information, the social networking system 140 allows the user to access communications about the case.

### Determining an Organization's Advertisement Spending

An organization may create several advertising accounts on the social networking system 140 and establish a connection between the organization and the various advertising accounts. Multiple nodes representing advertising accounts may be established at one time by the social networking system 140 receiving information from an organization describing multiple advertising accounts. Each advertising account may be connected to a user connected to the organization and having a relationship with the organization allowing the user to purchase advertisements on behalf of the organization. A user may be connected to multiple advertising accounts and to multiple organizations if the user is authorized to purchase advertisements on behalf of more than one organization. Additionally, if a user is no longer associated with an organization or its relationship with the organization otherwise changes, the connection between the user and an advertising account for the organization may be changed, deleted, or reassigned to another user, while the node representing the advertising account remains unchanged. For example, if a user connected to an advertising account resigns from his position with an organization, the edge connecting the user to the advertising account may be reassigned to a temporary employee assigned to the same position.

When the social networking system 140 receives a request from a user for how much money an organization spends advertising, the social networking system 140 may retrieve information describing the organization's connections to advertising accounts. For example, the social networking system 140 identifies nodes in a graph corresponding to advertising accounts connected to a node corresponding to the organization and analyzes information associated with the nodes corresponding to the advertising accounts. Information describing connections between the organization and the advertising accounts is used to determine the amount spend by the organization on the various advertising accounts. For example, the social networking system 140 totals financial information relating to advertising across the advertising accounts connected to the organization, such as the total amount of money the organization has spent across the advertising accounts, the total amount of money the organization has remaining to spend on advertising accounts, the total amount of money the organization has budgeted for advertising accounts, or other suitable information.

In one embodiment, a user may request other types of information about an organization from the social networking system 140. For example, a request may be for information about the number of employees working for an organization, about a number of product lines an organization is developing, or other suitable information. Before providing a requesting user with information about the organization, the social networking system 140 may determine if the user has a relationship with the organization authorizing access to the requested information. For example, if the request is for publicly available information, no relationship information is authenticated before providing the information; however, if the request is for private information, the user's relationship with the organization is accessed to determine if the user is authorized to receive the information.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
storing, in a social networking system, data describing an organization;
storing connections in the social networking system between the organization and one or more users maintained by the social networking system, a stored connection describing a relationship between a user and the organization;
receiving a request from a requesting user of a social networking system to take an action on behalf of the organization on the social networking system;
identifying a connection between the requesting user and the organization from the stored connections; and
performing the action on behalf of the organization if a relationship between the requesting user and the organization described by the connection between the requesting user and the organization allows the action.

2. The method of claim 1, wherein receiving the request from the requesting user of a social networking system to take the action on behalf of the organization on the social networking system comprises:
receiving a request to establish an additional connection between the requesting user and the organization.

3. The method of claim 2, performing the action on behalf of the organization comprises:
sending a request to the organization to authenticate the additional connection between the requesting user and the organization.

4. The method of claim 3, further comprising:
storing information associated with the additional connection between the requesting user authenticating the additional connection.

5. The method of claim 1, further comprising:
receiving a request from the organization to alter the relationship between the requesting user and the organization; and
modifying the connection between the requesting user and the organization to store the altered relationship between the requesting user and the organization.

6. The method of claim 1, further comprising:
receiving a request from the organization to remove the connection between the requesting user and the organization; and
removing the connection between the requesting user and the organization.

7. The method of claim 1, further comprising:
denying the action on behalf of the organization if the relationship between the requesting user and the organization described by the connection between the requesting user and the organization does not provide the user with authority to perform the action.

8. The method of claim 1, wherein performing the action on behalf of the organization if the relationship between the requesting user and the organization described by the connection between the requesting user and the organization allows the action comprises:
providing the requesting user with limited authority based on the relationship between the requesting user and the organization; and
performing the action on behalf of the organization based on the limited authority.

9. The method of claim 1, wherein the action comprises retrieving private information associated with the organization.

10. The method of claim 9, wherein performing the action on behalf of the organization if the relationship between the requesting user and the organization described by the connection between the requesting user and the organization allows the action comprises:
providing the private information to the requesting user if the relationship between the requesting user and the organization described by the connection indicates the requesting user is authorized to access the private information.

11. The method of claim 1, wherein the action comprises participating in a communication associated with the organization.

12. The method of claim 11, wherein performing the action on behalf of the organization if the relationship between the requesting user and the organization described by the connection between the requesting user and the organization allows the action comprises:
providing content associated with the communication to the requesting user if the relationship between the requesting user and the organization described by the connection indicates the requesting user has authority to participate in the communication.

13. A method comprising:
storing, in a social networking system, data describing an organization;
storing connections in the social networking system between the organization and one or more users maintained by the social networking system, a stored connection describing a relationship between a user and the organization;
receiving a request from an additional user of a social networking system on behalf of the organization associated with an organization to participate in a communication associated with the organization;
storing, in the social networking system, a connection between the additional user and an object describing the communication associated with the organization, the connection including an authorization from the organization for the additional user to participate in the communication;
receiving a request from the organization for an alternate user having a connection with the organization to participate in the communication; and
modifying the connection between the additional user and the object describing the communication to connect the object describing the communication with the alternate user.

14. The method of claim 13, wherein the communication is associated with a request for assistance from the social networking system.

15. The method of claim 13, wherein the communication is an exchange of data between the organization and an additional organization.

16. The method of claim 13, wherein the stored connection describing the relationship between the user and the organization includes one or more types of information selected from a group consisting of: authority to act on behalf of the organization, authority to access information about the organization, authority to access resources associated with the organization, or any combination thereof.

17. A method comprising:
storing, in a social networking system, data describing an organization;
storing connections in the social networking system between the organization and one or more users maintained by the social networking system, a stored connection describing a relationship between a user and the organization;
storing connections in the social networking system between the organization and one or more advertising accounts, each advertising account describing advertisements associated with the organization;
receiving a request for information about one or more advertising accounts associated with the organization from a requesting user of a social networking system;
identifying the one or more advertising accounts associated with the organization from the stored connections between the organization and the one or more advertising accounts;
retrieving information associated with the one or more advertising accounts; and
providing the retrieved information to the requesting user.

18. The method of claim 17, wherein the request for information about one or more advertising accounts associated with the organization comprises a request for an amount of resources spent on advertising by the organization.

19. The method of claim 17, wherein the request for information about one or more advertising accounts associated with the organization comprises a request for a total amount of resources allocated to advertising by the organization.

20. The method of claim 17, wherein the request for information about one or more advertising accounts associated with the organization comprises a request for an amount of resources available to be spent on advertising by the organization.

21. The method of claim 17, wherein providing the retrieved information to the requesting user comprises:
identifying a connection between the requesting user and the organization; and
providing the retrieved information to the requesting user if a relationship between the requesting user and the organization described by the connection between the requesting user authorizes the requesting user to receive the retrieved information.
